(19) United States
(12) Patent Application Publication
(10) Pub. No.: US 2014/0307605 A1
(43) Pub. Date: Oct. 16, 2014

(54) DATA TRANSMISSION METHOD OF MULTI-HOP NETWORK AND DEVICE USING THE SAME

(71) Applicant: Electronics and Telecommunications Research Institute, Daejeon (KR)

(72) Inventors: Sung Kee NOH, Daejeon (KR); Nam Seok KO, Daejeon (KR); Woo Sug JUNG, Daejeon (KR); Tae Soo CHUNG, Daejeon (KR); Sung Jin MOON, Daejeon (KR); Hwan Jo HEO, Daejeon (KR); Byung Ho YAE, Daejeon (KR); Jong Dae PARK, Daejeon (KR)

(73) Assignee: Electronics and Telecommunications Research Institute, Daejeon (KR)

(21) Appl. No.: 14/250,323

(22) Filed: Apr. 10, 2014

(30) Foreign Application Priority Data
Apr. 10, 2013 (KR) 10-2013-0039083

(51) Int. Cl. H04W 52/02; H04W 40/14

(52) U.S. Cl. CPC H04W 52/0219; H04W 40/14; H04W 84/18
USPC 370/311

(57) ABSTRACT

There are provided a data transmission method of a multi-hop network and a device using the same. The data transmission method of the multi-hop network according to the invention may include receiving information on the multi-hop network, receiving a predetermined desired communication reliability (DCR) of data transmission from a source node to a sink node, determining a single-hop packet transmission rate of each node from the source node to the sink node satisfying the predetermined desired DCR based on the information on the multi-hop network, and notifying each node configuring the multi-hop network of the single-hop packet transmission rate of each of the nodes. In the method and device according to the invention, it is possible to satisfy the DCR required for the multi-hop network and decrease energy consumption by minimizing the total number of transmitted packets.

### CLAIM FOR PRIORITY

This application claims priority to Korean Patent Application No. 2013-0039083 filed on Apr. 10, 2013 in the Korean Intellectual Property Office (KIPO), the entire contents of which are hereby incorporated by reference.

### BACKGROUND

1. Technical Field

Example embodiments of the present invention relate to data transmission of a multi-hop network, and more specifically, a data transmission method of a multi-hop network that can decrease total energy consumption while a desired communication reliability (DCR) is satisfied, and a device using the same.

2. Related Art

Wireless sensor networks (WSNs) started in military surveillance applications, and have since been increasingly used in various applications such as health, home, and transportation in recent years.

Data transmission in a WSN is based on multi-hop communication having a higher transmission loss in a wireless link than other networks. In order to overcome this transmission loss, loss-recovery algorithms for guaranteeing reliability of end-to-end communication have been proposed.

Typically, an active caching (AC) method of satisfying a desired communication reliability (DCR) is exemplified.

However, this algorithm causes another problem in that battery consumption increases in a resource-constrained WSN since retransmission is requested for all lost packets.

Therefore, a data transmission method minimizing energy consumption and increasing reliability is necessary in the WSN. That is, a method in which the reliability in the WSN is satisfied and the total number of transmitted packets through end-to-end communication serving as a direct factor of determining energy consumption of a sensor node is minimized is necessary.

### SUMMARY

Accordingly, example embodiments of the present invention are provided to substantially obviate one or more problems due to limitations and disadvantages of the related art.

Example embodiments of the present invention provide a data transmission method of decreasing energy consumption of a multi-hop network and satisfying a desired communication reliability (DCR) in the multi-hop network.

Example embodiments of the present invention also provide a data transmission device for decreasing energy consumption of a multi-hop network and satisfying a DCR in the multi-hop network.

In some example embodiments, a data transmission method of a multi-hop network in multi-hop data transmission from a source node to a sink node configuring the multi-hop network, includes receiving information on the multi-hop network, receiving a predetermined DCR of data transmission from the source node to the sink node, determining a single-hop packet transmission rate (Rᵢ) of each node (i) from the source node to the sink node satisfying the predetermined DCR based on the information on the multi-hop network, and notifying each node (i) configuring the multi-hop network of the single-hop packet transmission rate (Rᵢ) of each of the nodes (i).

In the determining of the single-hop packet transmission rate of each of the nodes, the single-hop packet transmission rate (Rᵢ) of each of the nodes (i) may be determined such that the total number of transmitted packets (Ω_{NTTP}) from the source node to the sink node is minimized and the DCR is satisfied.

The information on the multi-hop network may include the total number of data packets (Tₚ) in the source node, the total number of hops (H) from the source node to the sink node, and a packet delivery rate (Pᵢ) of each of the nodes.

The total number of transmitted packets (Ω_{NTTP}) from the source node to the sink node may be defined by

$${Ω}_{NTTP} = {T}_{P} {\sum }_{i = 1}^{H} \frac{{\prod }_{k = 1}^{i} {R}_{k}}{{P}_{i}} ( subject to {\prod }_{i = 1}^{H} {R}_{i} \geq DCR , {P}_{i} \leq {R}_{i} < 1 , where i = 1 , 2 , 3 , … , H ) .$$

The single-hop packet transmission rate (Rᵢ) of each of the nodes (i) may be determined by an optimization algorithm based on geometric programming for minimizing the total number of transmitted packets (Ω_{NTTP}) from the source node to the sink node.

The data transmission method of the multi-hop network may further include performing the multi-hop data transmission based on the single-hop packet transmission rate (Rᵢ) of each of the nodes (i).

In other example embodiments, a data transmission method of a multi-hop network, as an operation method of a node (i) in multi-hop data from a source node to a sink node configuring the multi-hop network, includes delivering information on a packet delivery rate (Pᵢ) from the node (i) to a node (i+1) to a super node, receiving a single-hop packet transmission rate (Rᵢ) from the node (i) to the node (i+1) from the super node, and performing data transmission of the node (i+1) based on the single-hop packet transmission rate (Rᵢ).

The super node may be the source node or the sink node included in the multi-hop network.

The single-hop packet transmission rate (Rᵢ) may be a value determined by the super node based on the information on the multi-hop network including the packet delivery rate (Pᵢ) of the node (i) in order to minimize the total number of transmitted packets (Ω_{NTTP}) from the source node to the sink node and satisfy the DCR.

The information on the multi-hop network may include the total number of data packets (Tₚ) in the source node, the total number of hops (H) from the source node to the sink node, and the packet delivery rate (Pᵢ) of each of the nodes.

The total number of transmitted packets (Ω_{NTTP}) from the source node to the sink node may be defined by

$${Ω}_{NTTP} = {T}_{P} {\sum }_{i = 1}^{H} \frac{{\prod }_{k = 1}^{i} {R}_{k}}{{P}_{i}} ( subject to {\prod }_{i = 1}^{H} {R}_{i} \geq DCR , {P}_{i} \leq {R}_{i} < 1 , where i = 1 , 2 , 3 , … , H ) .$$

The single-hop packet transmission rate (Rᵢ) of each of the nodes (i) may be determined by an optimization algorithm based on geometric programming for minimizing the total number of transmitted packets (Ω_{NTTP}) from the source node to the sink node.

In still other example embodiments, a data transmission device of a multi-hop network that performs multi-hop data transmission from a source node to a sink node configuring the multi-hop network, includes a multi-hop network information receiving unit configured to receive information on the multi-hop network, a DCR receiving unit configured to receive a predetermined DCR of data transmission from the source node to the sink node, a single-hop packet transmission rate determining unit configured to determine a single-hop packet transmission rate (Rᵢ) of each node (i) from the source node to the sink node satisfying the predetermined DCR based on the information on the multi-hop network, and a single-hop packet transmission rate notification unit configured to notify each node (i) configuring the multi-hop network of the single-hop packet transmission rate (Rᵢ) of each of the nodes (i).

The single-hop packet transmission rate determining unit may be configured to determine the single-hop packet transmission rate (Rᵢ) of each of the nodes (i) such that the total number of transmitted packets (Ω_{NTTP}) from the source node to the sink node is minimized and the DCR is satisfied.

The information on the multi-hop network may include the total number of data packets (Tₚ) in the source node, the total number of hops (H) from the source node to the sink node, and the packet delivery rate (Pᵢ) of each of the nodes.

The total number of transmitted packets (Ω_{NTTP}) from the source node to the sink node may be defined by

$${Ω}_{NTTP} = {T}_{P} {\sum }_{i = 1}^{H} \frac{{\prod }_{k = 1}^{i} {R}_{k}}{{P}_{i}} ( subject to {\prod }_{i = 1}^{H} {R}_{i} \geq DCR , {P}_{i} \leq {R}_{i} < 1 , where i = 1 , 2 , 3 , … , H ) .$$

The single-hop packet transmission rate (Rᵢ) of each of the nodes (i) may be determined by an optimization algorithm based on geometric programming for minimizing the total number of transmitted packets (Ω_{NTTP}) from the source node to the sink node.

The data transmission device of the multi-hop network may be included in the source node or the sink node in the multi-hop network.

The invention provides the method in which the DCR required in the wireless sensor network is satisfied and the total number of transmitted packets is minimized, and energy is thereby efficiently used. Additionally, when the data transmission method according to the invention is used, it is possible to decrease overhead due to a control packet for controlling data transmission.

Moreover, when the multi-hop data transmission method according to the invention is used, it is possible to decrease energy consumption of nodes and decrease a memory capacity of nodes required for operations.

High energy efficiency and availability according to the invention increase utilization of the wireless sensor network.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a data transmission method of a multi-hop network.

FIG. 2 is a conceptual diagram illustrating a data transmission method of the multi-hop network according to the invention.

FIG. 3 is a flowchart illustrating an example of the data transmission method of the multi-hop network according to the invention.

FIG. 4 is a flowchart illustrating another example of the data transmission method of the multi-hop network according to the invention.

FIG. 5 is a block diagram illustrating a data transmission device of the multi-hop network according to an embodiment of the invention.

### DESCRIPTION OF EXAMPLE EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the invention will be described in detail with reference to the accompanying drawings

Active Caching (AC) Method

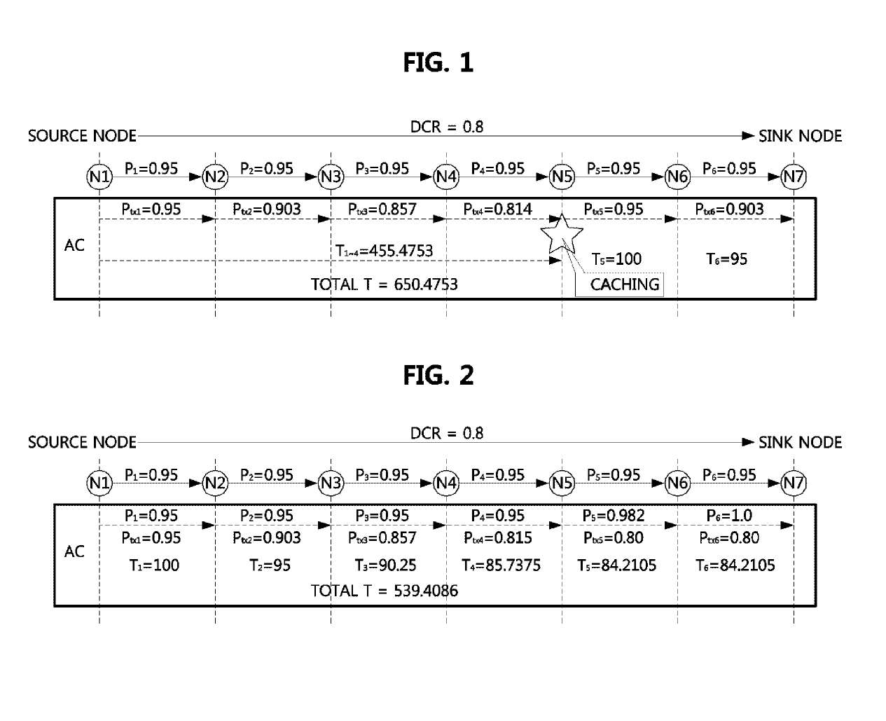

FIG. 1 is a conceptual diagram illustrating a data transmission method in a multi-hop network.

That is, FIG. 1 is a conceptual diagram illustrating a process of achieving a desired communication reliability (DCR) using an AC method.

As illustrated in FIG. 1, in a wireless sensor network composed of a multi-hop from a source node (n1) to a sink node (n7), an ith node has an accumulated packet transmission rate (Pₜₓᵢ) up to a next node, an (i+1)th node. For example, the accumulated packet transmission rate (Pₜₓ₁) from a node (n1) to a node (n2) is 0.95, the accumulated packet transmission rate (Pₜₓ₂) from a node (n2) to a node (n3) is 0.903, and the accumulated packet transmission rate (Pₜₓ₃) from a node (n3) to a node (n4) is 0.857. In general, the packet transmission rate is greatly affected by a packet loss rate of a wireless link and has independent characteristics in each node.

In an existing AC method, each node observes Pₜₓᵢ, serving as an actually transmitted packet transmission rate, data of which transmission has failed from the source node is requested again in a node that has failed to satisfy a required reliability in order to maintain a communication reliability up to the sink node, and all packets included in the source node are maintained again.

For example, as illustrated in FIG. 1, the packet transmission rate (Pₜₓ₅) from a 5th node (n5) to a 6th node (n6) is Pₜₓ₄(=0.814)×0.95=0.7733 when the AC method is not applied. Therefore, since the node (n5) has failed to satisfy the desired reliability (DCR=0.8), data of which transmission has failed from the source node is requested again, and all packet information included in the source node is maintained again. Accordingly, when the AC is applied, the packet transmission rate from the node (n5) to the node (n6) is set to 0.95, the same as the initial packet transmission rate from the node (n1) to the node (n2).

In this case, as the 5th node (n5), a node for maintaining all packet information included in the source node again is called a cache node. All subsequent transmission or retransmission is performed between the cache node and the sink node such that the DCR is satisfied.

The existing method can satisfy the DCR between the cache node and the sink node using a cache node function. However, since multi-hop retransmission from the source node to the cache node is required, many resources are wasted due to retransmission of lost packets.

In particular, since the total number of packets that are transmitted from the source node to the sink node is a direct factor of energy consumption of the wireless sensor network, it is important for a sensor network having limited energy to decrease the total number of transmitted packets.

A Method of Guaranteeing Communication Reliability According to the Invention

Accordingly, in the invention, an algorithm in which the communication reliability is guaranteed, the number of retransmitted packets decreases, and the total number of transmitted packets is minimized in the wireless sensor network is proposed.

Compared to the existing method in which all lost packets are multi-hop transmitted from the source node to the cache node, the method of guaranteeing the communication reliability according to the invention uses a method of calculating Rᵢ serving as an optimized single-hop communication reliability (packet transmission rate) of each node in order to satisfy end-end reliability from the source node to the sink node. Accordingly, the DCR is satisfied and the total number of transmitted packets is minimized. That is, in the invention, the DCR of total data transmission is satisfied by optimized operations of individual nodes.

To describe the proposed algorithm, symbols are defined first as follows.

Pᵢ: packet delivery rate from a node (i) to a node (i+1)

That is, the packet delivery rate is a value depending on the packet loss rate of the wireless link and each node has an independent packet delivery rate. That is, the packet delivery rate may refer to the number of packets that are losslessly delivered when 100 packets are transmitted from a node i to a node (i+1) (a property value of a link when retransmission is not considered).

Rᵢ: a single-hop packet transmission rate required in a link from a node (i) to a node (i+1) (one-hop packet transmission rate from node i to node i+1)

That is, the single-hop packet transmission rate refers to the packet transmission rate to be actually satisfied in a link from a node (i) to a node (i+1). That is, the single-hop packet transmission rate may refer to the number of packets to be actually delivered to a node (i+1) when 100 packets are transmitted from the node (i) to the node (i+1) (a target value to be satisfied by retransmission as necessary).

nᵢ: the number of retransmissions from a node (i) to a node (i+1) for satisfying the single-hop packet transmission rate (the number of retransmissions from node i to node i+1 while satisfying the one-hop packet transmission rate).
DCR: desired communication reliability (the desired CR for data packets generated from a source node)

That is, the DCR may refer to the number of packets to arrive at the sink node when 100 packets are transmitted from the source node to the sink node which configures the multi-hop network (a target value to be satisfied by retransmission as necessary).

Nᵢ: the number of packets that are initially transmitted from a node (i) (the number of transmitted packets in the first transmission at the node i).
Tₚ: the total number of data packets in a source node (the number of the whole data packets at a source). That is, Tₚ=N₁ is established.
H: the total number of hops from a source node to a sink node (the hop counts from a source to a sink).

The invention provides the method of setting the single-hop packet transmission rate optimized for each node in order to satisfy the DCR and minimize the total number of transmitted packets that are delivered from the source node to the sink node.

In order to count the total number of transmitted packets, the number of packets to be transmitted from a node (i) to a node (i+1), Ωᵢ, during retransmission of nᵢ may be calculated as the following Formula 1.

$${Ω}_{i} = {\sum }_{k = 0}^{{n}_{i} - 1} {{N}_{i} ( 1 - {P}_{i} )}^{k} = {N}_{i} ( \frac{1 - {( 1 - {P}_{i} )}^{{n}_{i}}}{{P}_{i}} ) \qquad Formula 1$$

During retransmission of nᵢ, the number of packets that are received in a node (i+1) from a node i, Ψᵢ₊₁, is expressed as the following Formula 2.

$${Ψ}_{i + 1} = {\sum }_{k = 0}^{{n}_{i} - 1} {{N}_{i} ( 1 - {P}_{i} )}^{k} {P}_{i} = {N}_{i} ( 1 - {( 1 - {P}_{i} )}^{{n}_{i}} ) \qquad Formula 2$$

When Ψᵢ₊₁=Nᵢ₊₁ and Rᵢ=1−(1−Pᵢ)ⁿ^{ᵢ} are satisfied, Nᵢ₊₁=NᵢRᵢ is established, therefore, the above Formula 1 may be re-expressed as the following Formula 3.

$${Ω}_{i} = {N}_{i} ( \frac{1 - {( 1 - {P}_{i} )}^{{n}_{i}}}{{P}_{i}} ) = {N}_{i} ( \frac{{R}_{i}}{{P}_{i}} ) \qquad Formula 3$$

When Ω_{NTTP} is defined as the total number of transmitted packets from the source node to the sink node, it is expressed as the following Formula 4.

$${Ω}_{NTTP} = {T}_{p} {\sum }_{i = 1}^{H} \frac{{\prod }_{k = 1}^{i} {R}_{k}}{{P}_{i}} \qquad Formula 4$$

Therefore, a transmission method of minimizing Ω_{NTTP} satisfying the DCR can be found using an optimization algorithm such as the following Formula 5. Values of Tₚ, H, and, Pᵢ are given in the above Formula 4, and a value of Rᵢ of each node needs to be found in order to minimize Ω_{NTTP}.

$$minimize {Ω}_{NTTP} = {T}_{P} {\sum }_{i = 1}^{H} \frac{{\prod }_{k = 1}^{i} {R}_{k}}{{P}_{i}} subject to {\prod }_{i = 1}^{H} {R}_{i} \geq DCR \\ {P}_{i} \leq {R}_{i} < 1 , where i = 1 , 2 , 3 , … , H \qquad Formula 5$$

The above optimization problem is known as geometric programming and may be addressed by optimization algorithms with reference to, for example, “Introduction to Algorithms,” by T. Cormen, C. Leiserson, R. Rivest, and C. Stein (The MIT Press, 2001).

Hereinafter, the data transmission method of the multi-hop network according to the invention will be described based on the above-described algorithm.

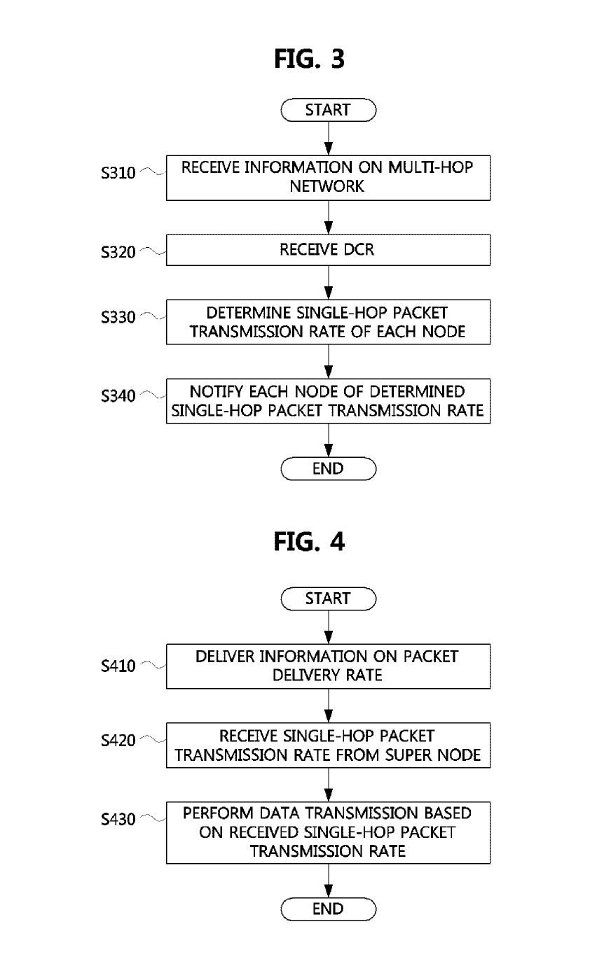

FIG. 2 is a conceptual diagram illustrating the data transmission method of the multi-hop network according to the invention and is described with reference to FIGS. 3 to 5 in parallel in descriptions of an operation method of a super node that governs an overall multi-hop network according to the invention and an operation method of an individual node configuring the multi-hop network.

First, as the data transmission method of the multi-hop network according to the invention, the operation method of the super node that governs the overall multi-hop network and the operation method of the individual node configuring the multi-hop network will be described. Then, as a configuration example of a device operated as the super node described above, a configuration of a data transmission management device of the multi-hop network according to the invention will be described.

FIG. 3 is a flowchart illustrating an example of the data transmission method of the multi-hop network according to the invention.

The data transmission method of the multi-hop network according to the invention described in FIG. 3 corresponds to a method of determining a single-hop data transmission rate for each node by the super node governing the multi-hop network. In this case, the super node is a name for expressing a role of the node. Typically, the role of the super node may be performed by the sink node configuring the multi-hop network. However, the source node may also perform the role of the super node. Otherwise, when all nodes from the source node to the sink node are determined, one of the nodes may perform the role of the super node.

As illustrated in FIG. 3, the data transmission method of the multi-hop network according to the invention may include an operation (S310) of receiving information on the multi-hop network, an operation (S320) of receiving a predetermined DCR, an operation (S330) of determining the single-hop packet transmission rate (Rᵢ) of each node (i) from the source node to the sink node satisfying the predetermined DCR based on the information on the multi-hop network, and an operation (S340) of notifying each node (i) from the source node to the sink node of the determined single-hop packet transmission rate (Rᵢ) of each of the nodes (i).

First, the operation (S310) is an operation of receiving, by the super node, information on a multi-hop network configuration including Tₚ, H, and Pᵢ described above. The super node may already know information on Tₚ and H along with the multi-hop network configuration and individually receive information on Pᵢ from configuration nodes of the configured multi-hop network.

For example, according to the embodiment exemplified in FIG. 2, Tₚ=N₁=100, H=6, and information on Pᵢ (i=1, . . . , 6) includes P₁=0.95, P₂=0.95, P₃=0.95, P₄=0.95, P₅=0.95, and P₆=0.95.

Next, the operation (S320) is an operation of receiving, by the super node, a value of the DCR of data transmission to be performed. Typically, the DCR of the data transmission is generally determined by an initiator (for example, the source node) of data transmission. The DCR of data transmission may be a value dependent on a property of data to be transmitted. For example, data transmission requiring a high reliability and data transmission requiring a relatively low reliability may coexist, and the operation (S320) is an operation of recognizing, by the super node, the DCR required for such data transmission.

For example, according to the embodiment exemplified in FIG. 2, DCR=0.8.

Next, the operation (S330) is an operation of determining the single-hop packet transmission rate (Rᵢ) of each node (i) from the source node to the sink node.

The operation (S330) is an operation of determining the single-hop packet transmission rate of each node (i) for minimizing the total number of transmitted packets (Ω_{NTTP}) from the source node to the sink node derived from the above-described Formulas 1 to 4, and may be performed using optimization algorithms. The optimization problem is known as geometric programming, and may be addressed by a variety of optimization algorithms.

Finally, the operation (S340) is an operation of notifying each node (i) configuring the multi-hop network of the determined single-hop packet transmission rate (Rᵢ) of each of the nodes (i).

That is, the super node notifies each node (i) configuring the multi-hop network of the determined single-hop packet transmission rate (Rᵢ) of each of the nodes (i). Since the single-hop packet transmission rate is not necessary for the sink node, there is no need to notify of the single-hop packet transmission rate of the sink node. Furthermore, since the super node already knows its own single-hop packet transmission rate through the operation (S330), no notifying process is necessary.

Each node notified of the single-hop packet transmission rate (Rᵢ) in the above operation (S340) performs data transmission based on the notified single-hop packet transmission rate. That is, each node (i) maintains the notified single-hop packet transmission rate (Rᵢ) by performing retransmission of the node (i+1) as necessary. According to the invention, the DCR of overall data transmission is satisfied by optimized operations of individual nodes.

Hereinafter, in order to implement the data transmission method of the multi-hop network according to the invention described above, a unit operation of each node configuring the multi-hop network will be described. The following description relates to operations of general nodes configuring the multi-hop network other than the super node described in FIG. 3.

FIG. 4 is a flowchart illustrating another example of the data transmission method of the multi-hop network according to the invention.

As illustrated in FIG. 4, as an operation method of a node (i) in multi-hop data from the source node to the sink node which configure the multi-hop network, the data transmission method of each node that participates in data transmission of the multi-hop network according to the invention may include an operation (S410) of delivering information on packet delivery rate (Pᵢ) from the node (i) to a node (i+1) to the super node, an operation (S420) of receiving the single-hop packet transmission rate (Rᵢ) from the node (i) to the node (i+1) from the super node, and an operation (S430) of performing data transmission of the node (i+1) based on the single-hop packet transmission rate (Rᵢ).

First, the operation (S410) is an operation of providing, by each node, the packet delivery rate (Pᵢ) information thereof to the super node as a procedure corresponding to the operation (S310) described in FIG. 3. The super node receives information on the packet delivery rate (Pᵢ) of each node configuring the multi-hop network from each node, directly recognizes information on Tₚ and H that is information on the multi-hop network configuration, or receives the information from the source node.

Next, the operation (S420) is an operation of receiving the single-hop packet transmission rate (Rᵢ) of each node that is determined in the super node in the above operation (S330). This operation corresponds to the operation (S340) in the operation method of the super node described above.

The process of determining the single-hop packet transmission rate has already been described and the description thereof will not be repeated.

Finally, the operation (S430) is an operation of performing data transmission of the node (i+1) based on the single-hop packet transmission rate (Rᵢ) received in the operation (S420). That is, each node (i) maintains the notified single-hop packet transmission rate (Rᵢ) by performing retransmission of the node (i+1) as necessary. As described above, according to the invention, the DCR of overall data transmission is satisfied by optimized operations of individual nodes.

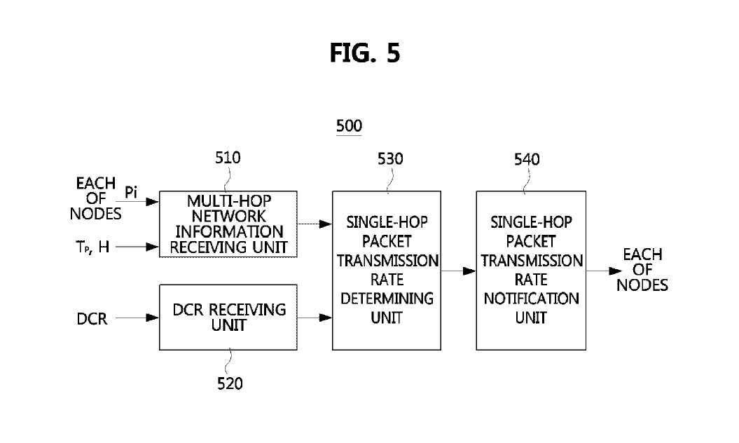

FIG. 5 is a block diagram illustrating a data transmission device of the multi-hop network according to the embodiment of the invention.

The data transmission device of the multi-hop network described in FIG. 5 corresponds to a device for managing data transmission of the multi-hop network. That is, the data transmission device of the multi-hop network described in FIG. 5 may be included in the super node (for example, the sink node or the source node) in the multi-hop network.

As illustrated in FIG. 5, a data transmission device 500 of the multi-hop network according to the invention may include a multi-hop network information receiving unit 510 configured to receive information on the multi-hop network, a DCR receiving unit 520 configured to receive a predetermined DCR of data transmission from the source node to the sink node, a single-hop packet transmission rate determining unit 530 configured to determine the single-hop packet transmission rate (Rᵢ) of each node (i) from the source node to the sink node satisfying the predetermined DCR based on the information on the multi-hop network, and a single-hop packet transmission rate notification unit 540 configured to notify each node (i) configuring the multi-hop network of the single-hop packet transmission rate (Rᵢ) of each of the nodes (i).

First, the multi-hop network information receiving unit 510 is a component for receiving information on the multi-hop network configuration including Tₚ, H and Pᵢ described above. The super node may already know information on Tₚ and H along with the multi-hop network configuration and individually receive information on Pᵢ from configuration nodes of the configured multi-hop network.

For example, according to the embodiment exemplified in FIG. 2, Tₚ=N₁=100, H=6, and information on Pᵢ (i=1, . . . , 6) includes P₁=0.95, P₂=0.95, P₃=0.95, P₄=0.95, P₅=0.95, and P₆=0.95.

Next, the DCR receiving unit 520 is a component for receiving a value of the DCR of data transmission to be performed. The DCR of data transmission may also be a value dependent on a property of data to be transmitted. For example, data transmission requiring a high reliability and data transmission requiring a relatively low reliability may coexist.

Next, the single-hop packet transmission rate determining unit 530 is a component for determining the single-hop packet transmission rate (Rᵢ) of each node (i) from the source node to the sink node.

The single-hop packet transmission rate determining unit 530 may determine the single-hop packet transmission rate (Rᵢ) of each node (i) for minimizing the total number of transmitted packets (Ω_{NTTP}) from the source node to the sink node derived from the above Formulas 1 to 4 using optimization algorithms.

Finally, the single-hop packet transmission rate notification unit 540 is a component for notifying each node (i) configuring the multi-hop network of the determined single-hop packet transmission rate (Rᵢ) of each of the nodes (i). That is, the single-hop packet transmission rate notification unit 540 notifies each node configuring the multi-hop network of the single-hop packet transmission rate (Rᵢ) of each node (i) determined by the single-hop packet transmission rate determining unit 530.

Performance Analysis

Hereinafter, the method of guaranteeing the DCR using the AC method described in FIG. 1 and the method of guaranteeing the DCR according to the invention described in FIG. 2 are compared.

In both methods, the DCR is set to 0.8. It is assumed that each node has the packet delivery rate of 95% and the number of hops from the source node to the sink node is 6.

### 1) Effect of Decreasing the Total Number of Transmitted Packets

The AC method and the method of guaranteeing the DCR according to the invention are compared in terms of the total number of transmitted packets.

As illustrated in FIG. 1, in the AC method, since the DCR of 80% is not satisfied in the node (n5), the node (n5) is used as the cache node and requests retransmission of all lost packets from the source node. Therefore, when it is assumed that the number of packets that are transmitted from the node (n1) to the node (n2) is 100, the number (T₁₋₄) of packets that are transmitted from the node (n1) to the node (n5) is 455.4753, the total number of packets (T₅) from the node (n5) to the node (n6) is 100, and the total number of packets (T₆) from the node (n6) to the node (n7) is 95. Accordingly, the total number of transmitted packets (Total T) is 650.4753.

Meanwhile, as illustrated in FIG. 2, in the method according to the invention, the single-hop packet transmission rate of each node (ni) is set to R₁=0.95, R₂=0.95, R₃=0.95, R₄=0.95, R₆=0.982, and R₇=1.0. In this case, when it is assumed that the number of packets that are transmitted from the node (n1) to the node (n2) is 100, the total number of transmitted packets (Total T) is 539.4086.

Therefore, in the above-described embodiment, the method according to the invention results in decreasing of the total number of packets from 650.4753 to 539.3086 compared to the case in which the AC method is applied. This means that energy consumption used for data transmission of the overall multi-hop network can also be decreased.

### 2) Effect of Decreasing Overhead Due to Control Packet

In the AC method, whenever the cache node requests retransmission from a previous initiating node or the source node, a control packet is generated and sent. For example, in the embodiment described in FIG. 1, the cache node (n5) requests the retransmission 11 times from the source node, and the control packet for requesting retransmission is transmitted from the cache node (n5) to the source node (n1) through a multi-hop connection. That is, the control packet is transmitted 44 times from the node (n5) to the source node (n1).

On the other hand, in the data transmission according to the invention, the super node (for example, the sink node) receives information on Pᵢ of each node from each node and only 12 control packets are necessary for delivering information on Rᵢ of each node calculated by the super node to each node. Moreover, since retransmission requests need only be performed between the node (n5) and the node (n6), and between the node (n6) and the node (n7), only 7 and 6 control packets, respectively, are necessary.

Therefore, in the embodiment described above, while transmission of 44 control packets is necessary in the AC method, only transmission of 12+7+6=25 control packets is necessary in the method according to the invention.

### 3) Effect of Decreasing a Required Memory Capacity

As described above, the cache node in the AC method requests and stores all data packets of the source node in order to satisfy the DCR.

This means that each cache node needs a sufficient memory capacity for storing all data packets of the source node. As the packet delivery rate varies, the cache node and a number of the cache node can be changed. Therefore, when the AC method is applied, all nodes configuring the multi-hop network have a possibility to be the cache node. This means that all nodes need to be implemented with the sufficient memory capacity.

However, when the method according to the invention is used, since the cache node is not necessary in the multi-hop network, each node needs only a memory capacity that can store data packets for performing retransmission of subsequent nodes.

While the example embodiments of the present invention and their advantages have been described in detail, it should be understood that various changes, substitutions and alterations may be made herein without departing from the scope of the invention as defined by the following claims.

### REFERENCE NUMERALS

500: multi-hop network data transmission device
510: multi-hop network information receiving unit
520: DCR receiving unit
530: single-hop packet transmission rate determining unit
540: single-hop packet transmission rate notification unit

What is claimed is:

1. A data transmission method of a multi-hop network in multi-hop data transmission from a source node to a sink node configuring the multi-hop network, the method comprising:
receiving information on the multi-hop network;
receiving a predetermined desired communication reliability (DCR) of data transmission from the source node to the sink node;
determining a single-hop packet transmission rate (Rᵢ) of each node (i) from the source node to the sink node satisfying the predetermined DCR based on the information on the multi-hop network; and
notifying each node (i) configuring the multi-hop network of the single-hop packet transmission rate (Rᵢ) of each of the nodes (i).

2. The method of claim 1, wherein, in the determining of the single-hop packet transmission rate of each of the nodes, the single-hop packet transmission rate (Rᵢ) of each of the nodes (i) is determined such that the total number of transmitted packets (Ω_{NTTP}) from the source node to the sink node is minimized and the DCR is satisfied.

3. The method of claim 2, wherein the information on the multi-hop network includes the total number of data packets (Tₚ) in the source node, the total number of hops (H) from the source node to the sink node, and a packet delivery rate (Pᵢ) of each of the nodes.

4. The method of claim 3, wherein the total number of transmitted packets (Ω_{NTTP}) from the source node to the sink node is defined by
$${Ω}_{NTTP} = {T}_{P} {\sum }_{i = 1}^{H} \frac{{\prod }_{k = 1}^{i} {R}_{k}}{{P}_{i}} ( subject to {\prod }_{i = 1}^{H} {R}_{i} \geq DCR , {P}_{i} \leq {R}_{i} < 1 , where i = 1 , 2 , 3 , … , H ) .$$

5. The method of claim 4, wherein the single-hop packet transmission rate (Rᵢ) of each of the nodes (i) is determined by an optimization algorithm based on geometric programming for minimizing the total number of transmitted packets (Ω_{NTTP}) from the source node to the sink node.

6. The method of claim 1, further comprising performing the multi-hop data transmission based on the single-hop packet transmission rate (Rᵢ) of each of the nodes (i).

7. A data transmission method in a multi-hop network, as an operation method of a node (i) in multi-hop data from a source node to a sink node configuring the multi-hop network, the method comprising:
delivering information on a packet delivery rate (Pᵢ) from the node (i) to a node (i+1) to a super node;
receiving a single-hop packet transmission rate (Rᵢ) from the node (i) to the node (i+1) from the super node; and
performing data transmission of the node (i+1) based on the single-hop packet transmission rate (Rᵢ).

8. The method of claim 7, wherein the super node is the source node or the sink node included in the multi-hop network.

9. The method of claim 7, wherein the single-hop packet transmission rate (Rᵢ) is a value determined by the super node based on the information on the multi-hop network including the packet delivery rate (Pᵢ) of the node (i) in order to minimize the total number of transmitted packets (Ω_{NTTP}) from the source node to the sink node and satisfy a desired communication reliability.

10. The method of claim 9, wherein the information on the multi-hop network includes the total number of data packets (Tₚ) in the source node, the total number of hops (H) from the source node to the sink node, and the packet delivery rate (Pᵢ) of each of the nodes.

11. The method of claim 10, wherein the total number of transmitted packets (Ω_{NTTP}) from the source node to the sink node is defined by
$${Ω}_{NTTP} = {T}_{P} {\sum }_{i = 1}^{H} \frac{{\prod }_{k = 1}^{i} {R}_{k}}{{P}_{i}} ( subject to {\prod }_{i = 1}^{H} {R}_{i} \geq DCR , {P}_{i} \leq {R}_{i} < 1 , where i = 1 , 2 , 3 , … , H ) .$$

12. The method of claim 11, wherein the single-hop packet transmission rate (Rᵢ) of each of the nodes (i) is determined by an optimization algorithm based on geometric programming for minimizing the total number of transmitted packets (Ω_{NTTP}) from the source node to the sink node.

13. A data transmission device of a multi-hop network that performs multi-hop data transmission from a source node to a sink node configuring the multi-hop network, the device comprising:
a multi-hop network information receiving unit configured to receive information on the multi-hop network;
a desired communication reliability (DCR) receiving unit configured to receive a predetermined DCR of data transmission from the source node to the sink node;
a single-hop packet transmission rate determining unit configured to determine a single-hop packet transmission rate (Rᵢ) of each node (i) from the source node to the sink node satisfying the predetermined DCR based on the information on the multi-hop network; and
a single-hop packet transmission rate notification unit configured to notify each node (i) configuring the multi-hop network of the single-hop packet transmission rate (Rᵢ) of each of the nodes (i).

14. The device of claim 13, wherein the single-hop packet transmission rate determining unit is configured to determine the single-hop packet transmission rate (Rᵢ) of each of the nodes (i) such that the total number of transmitted packets (Ω_{NTTP}) from the source node to the sink node is minimized and the DCR is satisfied.

15. The device of claim 14, wherein the information on the multi-hop network includes the total number of data packets (Tₚ) in the source node, the total number of hops (H) from the source node to the sink node, and the packet delivery rate (Pᵢ) of each of the nodes.

16. The device of claim 15, wherein the total number of transmitted packets (Ω_{NTTP}) from the source node to the sink node is defined by
$${Ω}_{NTTP} = {T}_{P} {\sum }_{i = 1}^{H} \frac{{\prod }_{k = 1}^{i} {R}_{k}}{{P}_{i}} ( subject to {\prod }_{i = 1}^{H} {R}_{i} \geq DCR , {P}_{i} \leq {R}_{i} < 1 , where i = 1 , 2 , 3 , … , H ) .$$

17. The device of claim 16, wherein the single-hop packet transmission rate (Rᵢ) of each of the nodes (i) is determined by an optimization algorithm based on geometric programming for minimizing the total number of transmitted packets (Ω_{NTTP}) from the source node to the sink node.

18. The device of claim 13, wherein the data transmission device of the multi-hop network is included in the source node or the sink node in the multi-hop network.
